(19) United States
(12) Patent Application Publication
(10) Pub. No.: US 2012/0096290 A1
(43) Pub. Date: Apr. 19, 2012

(54) Distributed Architecture for Situation Aware Sensory Application

(75) Inventors: Mark B. Shkolnikov, Herndon, VA (US); Diana Shkolnikov, Furlong, PA (US); Anatoly V. Boshkin, Herndon, VA (US)

(73) Assignee: Keynetik, Inc., Herndon, VA (US)

(21) Appl. No.: 13/273,838

(22) Filed: Oct. 14, 2011

Related U.S. Application Data
(60) Provisional application No. 61/393,073, filed on Oct. 14, 2010.

(51) Int. Cl. G06F 1/26

(52) U.S. Cl. 713/320

(57) ABSTRACT

Embodiments of the invention relate to a distributed signal processing system and a method for processing a sensor signal for a mobile device. Raw signal data is received and pre-processed by a processor to filter and split the data signal into multiple data outputs. The split signal data represent both spatial and spectral components, and/or statistical properties pertaining to the sensor. Low rate processing data is communicated to a second processor for limited data processing by select logic components.

### CROSS REFERENCE TO RELATED APPLICATION(S)

This is a non-provisional utility patent application claiming the benefit of the filing date of U.S. Provisional Patent Application Ser. No. 61/393,073, filed Oct. 14, 2010, and titled “Distributed Architecture for Situation Awareness Sensory Applications,” which is hereby incorporated by reference.

### BACKGROUND

This invention relates to integration of a sensor into a mobile telecommunication device. More specifically, the invention relates to processing sensory data in a manner that mitigates computation and reduces power consumption.

The proliferation of motion and other types of sensors into mobile devices enables new applications that take advantage of data gathered from the sensors. One of the new applications is known as a natural user interface (NUI), which is effectively invisible, or becomes invisible with successive learned interaction, to its users. The word natural is used because most computer interfaces use artificial control commands which have to be learned. A NUI relies on a user being able to carry out relatively natural motions, movements or gestures that control the computer application or manipulate the on-screen content. An important component of the NUI is an ability to detect placement of the device. Another desired component of the NUI is an ability to detect and classify background activity and to separate such background activity from intentional user movements. In other cases it may be desirable to restrict certain classes of activity depending upon the environment, such as driving and texting.

One of the challenges of implementing intelligent sensory application on a mobile device is limitations associated with computing abilities and battery power. A common set of environmental sensors that are currently available in mobile devices include: accelerometers, gyroscopes, magnetometers, proximity sensors, light sensors, and pressure sensors. Prior art approaches to processing data acquired from these environmental sensors for situation awareness purposes is computationally prohibitive with a mobile device. Accordingly, there is a need for a solution that employs sensor data in a mobile device that overcomes the limitations associated with computing abilities and battery power.

### BRIEF SUMMARY

This invention comprises a method, system, and article for mitigating power consumption of sensory data of a mobile device while supporting deriving device placement information and/or situational awareness data associated with the device.

In one aspect, a method is provided for efficient and effective motion signal processing. One or more sensors are provided in communication with at least two processors. More specifically, a first processor is provided in communication with a second processor, with the first processor configured to pre-process signal data from the one or more sensors for the second processor. The signal pre-processing includes converting a high rate raw data stream from the one or more sensors into a low rate data stream of extracted features. The second processor is configured with two or more logic elements, and with each logic element configured to process the low rate data stream for a defined set of extracted features. Each of the configured logic elements of the second processor is selectively operated. The selectivity includes transitioning one of the select logic elements from a low power state to a high power state to support feature processing, and transitioning one of the select logic elements operating at the high power state to the low power state at a conclusion of feature processing.

In another aspect, a system is provided for motion signal processing of a mobile device. More specifically, a mobile device is provided with a sensor to generate a motion signal. A computer system is provided in communication with the mobile device. The computer system includes a first processor and a second processor in communication with memory. The first processor is configured to pre-process signal data from the sensor for the second processor, with the pre-processed signal data including a conversion of high rate raw data from the sensor into a low rate data stream of extracted features. The second processor is configured with two or more logic elements, with each logic element to process the low rate data stream for a defined set of extracted features. A functional unit is provided in communication with the memory. More specifically, the functional unit includes a logic manager to selectively operate each configured logic element of the second processor. The logic manager executes a first transition of one or more of the logic elements from a low power state to support feature processing, and executes a second transition of a logic element operating at a high power state to the low power state at a conclusion of feature processing.

In yet another aspect, a computer program product is provided for use with a mobile device to process motion data received from a sensor. More specifically, the mobile device is configured with a sensor to generate a motion signal. The computer program product includes a computer readable storage medium having computer readable program code embodied thereon, which when executed causes a computer to implement instructions to support processing of sensor data. A first processor is provided in communication with a second processor, with the second processor configured with two or more logic elements. Each of these logic elements is configured to process a low rate data stream for a defined set of features extracted from the sensor data by the first processor. More specifically, the first processor receives data from at least one of the sensors, and pre-processes the signal data. The pre-processing includes: converting a high rate raw data stream from the one or more sensors into a low rate data stream of extracted features, and selectively operating each configured logic element of the second processor. The select logic elements are transitioned from a low power state to a high power state to support feature processing, and transitioned from the high power state to the low power state at a conclusion of feature processing.

Other features and advantages of this invention will become apparent from the following detailed description of the presently preferred embodiments of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a block diagram illustrating the physical arrangement of the sensor(s) with respect to a processor for evaluating sensor data.

FIG. 2A is a block diagram showing two sensors in communication with a standalone sensor processor, which is in communication with an application processor.

FIG. 2B is a block diagram showing two sensors packaged with the sensor processor, and the packaged sensors in communication with the application processor.

FIG. 2C a block diagram showing two processors in communication with sensors arranged in a package.

FIG. 3 is a flow chart illustrating a process for employing the sensor processor and the application processor to extract features from data generated by the sensor.

FIG. 4 is a flow chart illustrating a process for reducing the amount of sensory data.

FIG. 5 is a block diagram illustrating the interrelationship between the width of a frequency spectrum and the quantity of samples within the spectrum.

FIG. 6 is a block diagram illustrating tabled data with the Haar wavelet transform consecutively applied.

FIG. 7 is a block diagram illustrating parsing of data by the sensor processor and communication of the processed data to the application processor.

FIG. 8 is a flow chart illustrating functionality of the filter bank pertaining to situation awareness features.

FIG. 9 is a flow chart illustrating a process for changing an operating mode of one or more select logic elements embedded within the application processor.

FIG. 10 is a flow chart illustrating functionality of sensor logic framework with respect to transition detection.

FIG. 11 is a block diagram illustrating a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of one or more managers, processors, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

The continuous use of sensors in electronic devices presents several challenges, including power consumption. The sensors consume power for most uses, including polling and obtaining data. For example, polling the sensors continuously consumes power. Some categories of polling, such as data polling for situation awareness purposes, consume data at a high rate which further increases power consumption. Accordingly, there is a need to distribute signal processing of sensory data to minimize both signal processing and power consumption.

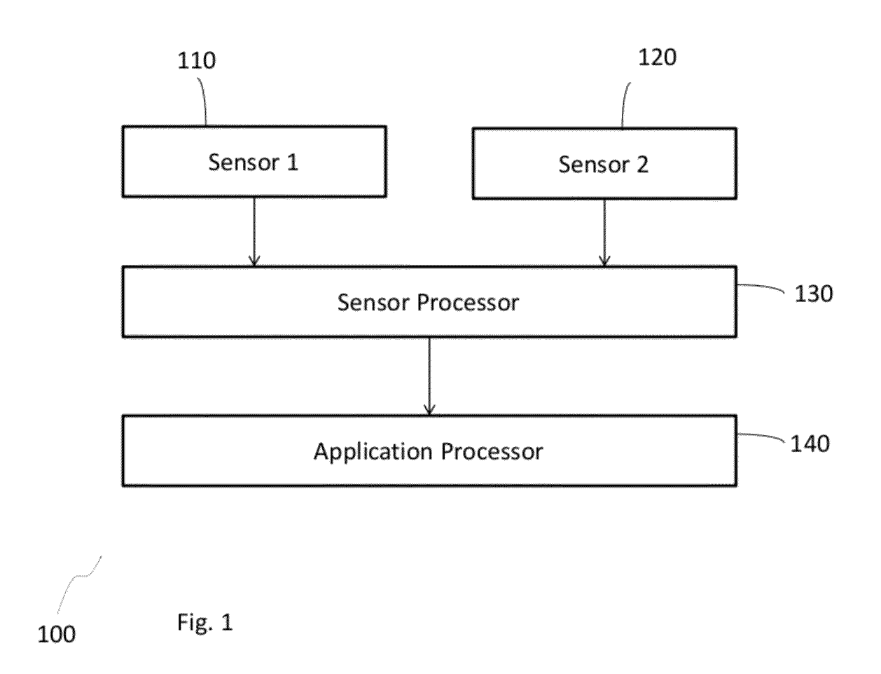

A method and system are provided for use in a mobile device having a sensor in communication with a processor, with the combination of these elements to support a sensory application. More specifically, the arrangement of processors distributes signal data processing to mitigate both signal processing and power consumption by any single processor. FIG. 1 is a block diagram (100) illustrating the physical arrangement of the sensor(s) with respect to a processor for evaluating sensor data. As shown, at least two sensors (110) and (120) are in direct communication with a sensor processor (130). All data gathered by the sensors (110) and (120) are communicated to the sensor processor (130). Accordingly, the sensor processor (130) functions as a first tier processor to process sensor data.

The sensor processor (130) is also referred to herein as a low power processor. More specifically, the sensor processor is employed for a first level of sensor data processing to reduce a quantity of computations that may need to be completed. As shown herein, the sensor processor (130) is in communication with an application processor (140). Data that has been processed from the sensor processor (130) is communicated to the application processor (140) for further processing. In one embodiment, the application processor (140) is referred to as a high power processor, and in another embodiment as a second level of sensor data processing. Based upon the hierarchical representation of the sensor and processors, the application processor receives a reduced quantity of data than the sensor processor. More specifically, the sensor processor (130) is considered herein to pre-process sensory data from the sensors (110) and (120), The pre-processed data actually reduces the quantity of data remaining to be processed, thereby minimizing overall computations and power consumption by the application processor. Accordingly, the sensor processor filters the signal and extracts generic sensory signal features that are relevant to all sensory applications, thus centralizing computationally intensive filtering and eliminating duplication of filtering by independent applications.

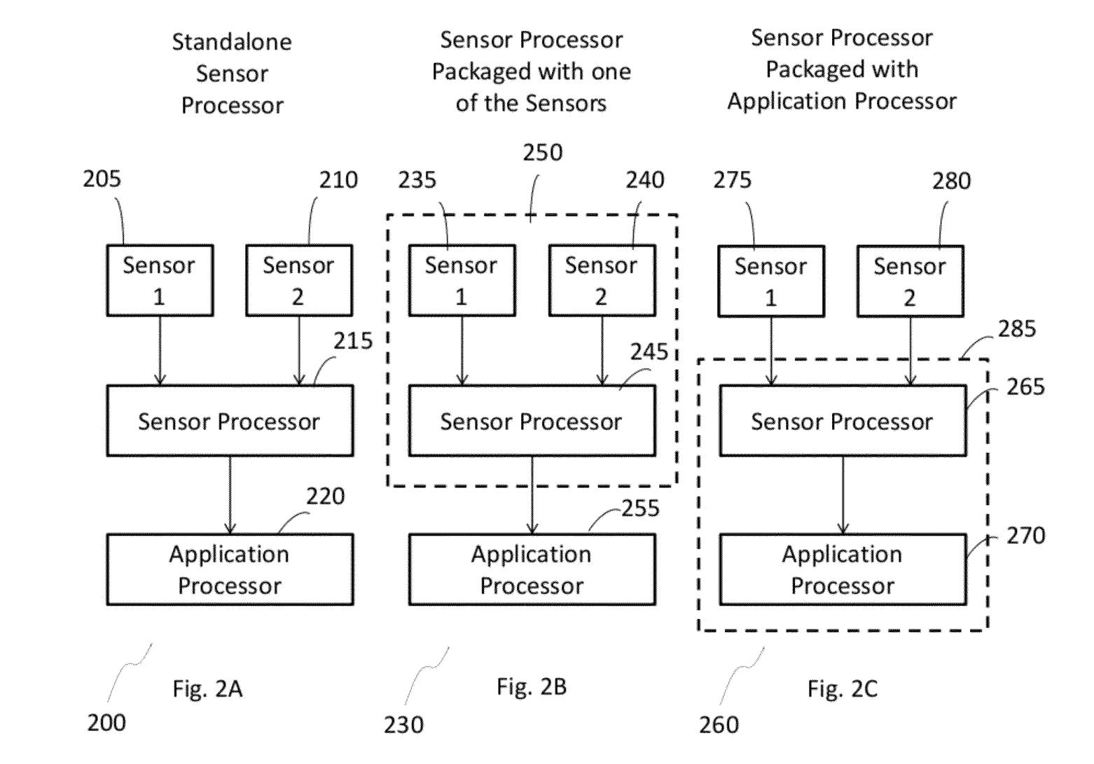

FIG. 1 is an abstraction of the relationship of the sensors to the processors. FIGS. 2A-2C show different arrangements of the sensors and processors. FIG. 2A is a block diagram (200) showing two sensors (205) and (210) in communication with a standalone sensor processor (215), which is in communication with an application processor (220). Sensor processor (215) is electronically separate from the application processor (220). Processors (215) and (220) may be on the same substrate or on separate substrates. FIG. 2B is a block diagram (230) showing two sensors (235) and (240) packaged with the sensor processor (245), with the package referred to herein as (250), and the package (250) is in communication with the application processor (255). In this embodiment, the sensor processor (245) is local to the sensors (235) and (240), with the application processor (255) in remote communication with the package (250). FIG. 2C is a block diagram (260) showing two processors (265) and (270) arranged in a package (285) with the package (285) in communication with the sensors (275) and (280). More specifically, the sensor process (265) is packaged with the application processor (270), with the package (285) in communication with the sensors (265) and (270). Accordingly, as shown there are different combinations and permutations for the arrangement of sensors and processors.

In each of the arrangements shown in FIGS. 2A, 2B, and 2C, the sensor processor is configured to pre-process sensory data received from the sensors. More specifically, the sensor processor is a low power processor configured to mitigate power consumption associated with signal processing. The pre-processed sensory data is communicated from the sensor processor to the application processor, which operates at a high power level. In one embodiment, the sensor processor is configured to extract designated data to mitigate the data rate exchange between the sensor processor and the application processor. Similarly, in another embodiment, the application processor or logic embedded within the application processor functions in a sleep or hibernate state when not subject to processing, but wakes from the sleep or hibernate state to a full power state following communication of data from the sensor processor. The low power state of sleep or hibernate associated with select logic embedded in the processor or the entire processor conserves power at such time as the application processor or the select logic is not subject to processing data. Accordingly, by sharing processing responsibility between two processors, with the sensor processor operating to pre-process sensor data, overall computations and power consumption by the application processor are minimized.

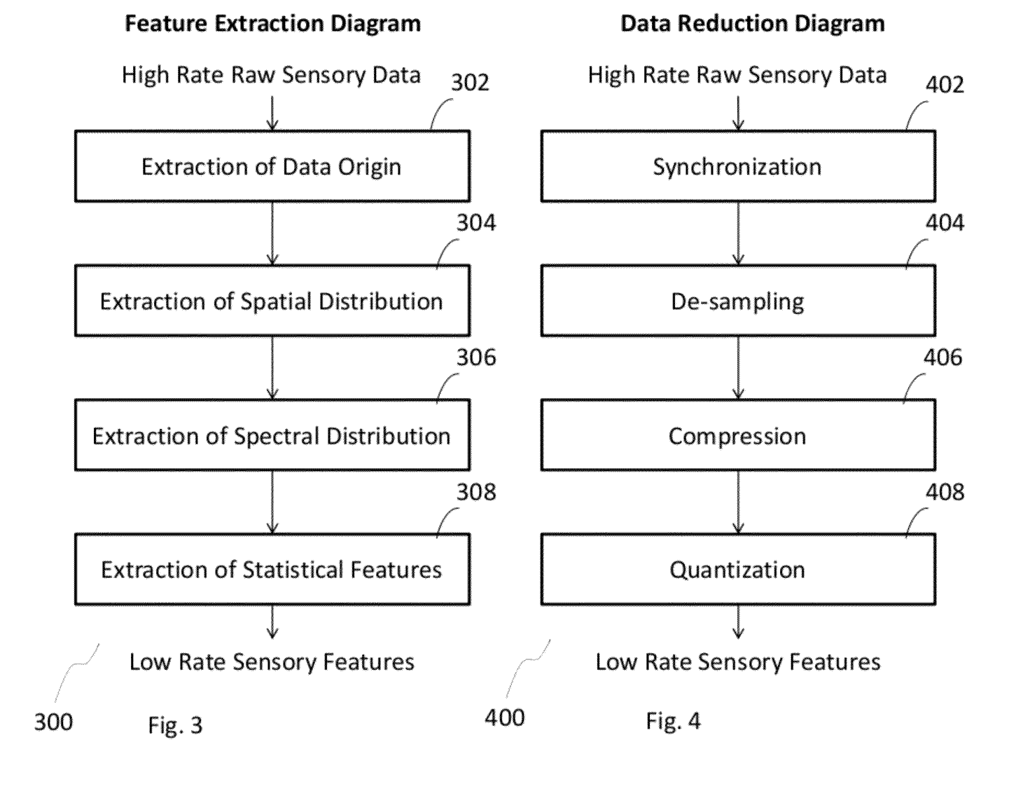

As shown in FIGS. 1 and 2A-2C, the sensors are in communication with at least two processors, which may be arranged in a hierarchical manner. A method is employed with the physical sensor and processor arrangements to eliminate filtering of the sensory signal by sensory applications running on the application processor and to reduce the amount of data transmitted from the sensor processor to the application processor. The reduction of data takes place by reducing sensory data to a set of features, which is shown in detail in FIG. 3, and by reducing data, which is shown in detail in FIG. 4.

The functionality of FIGS. 3 and 4 operating in parallel. FIG. 3 is a flow chart (300) illustrating a process for employing the sensor processor to extract features from data generated by the sensor. More specifically, FIG. 3 illustrates a sequence of how desired sensory signal characteristics or features are preserved and extracted. Initially, the sensor data is dissected to preserve the origin of the data (302). The origin is essentially the sensor element that has provided the data, e.g. the accelerometer or gyroscope. It is important to keep the original of the data because it can be used to determine the level of confident of the data based on its origin. Following the extraction at step (302), spatial distribution elements are extracted (304). Motion sensors, accelerometers, magnetometers, and gyroscopes output their data in a vector form. The filter bank keeps all dimensions of the sensor data separate allowing for later alignment of the sensory signal with Earth reference frame. The spectral distribution extraction (306) is achieved by sequential filtering of the sensory signal by a set of low pass and high pass filters. After each step of filtering, the signal spectrum is reduced. As the result, we are getting spectrally sliced sensory signal. Once the signal is dissected spatially and spectrally, it is possible to compute or extract various statistical properties (308) for each desired spatial dimension and frequency band. For low frequency band such features are various averages, e.g. geometrical or arithmetic, ranges, modes, etc. For high frequency bands such features are variances, ranges, correlations, etc.

FIG. 4 is a flow chart (400) illustrating a process for turning high rate sensory data into a low rate stream of statistical features. The data reduction process takes place in parallel to the feature extraction. The first step is synchronization which is essentially alignment of the sensory data polled at different frequencies. The synchronization is achieved by synchronizing filter bank buffers. The de-sampling (404) is happening simultaneously with spectral filtering when the latter is performed by orthogonal wavelets, such as Haar. Each application of the orthogonal wavelet evenly divides the spectrum and reduces the number of samples two times for each frequency band. Thus low frequency changes of orientation required by user interface and other applications can be provided at a much lower rate than the raw signal.

The compression (406) allows further reduction of the sensory data. For example, the most demanding situation awareness component, the device placement detection requires only overall power of high frequency noises and does not require knowing their spatial distribution. Thus, it is possible to convert a large amount of data samples for a high frequency band into a single number indicative of the energy of the noise over a period of time, such as signal variance. In many cases it is possible to further reduce the size of a feature by quantization (408). For example, instead of providing an actual number for the variance, it is possible to replace is with a qualitative characteristic such as big or small, strong or weak. The quantization can reduce the size of the feature from several bits to a single bit, e.g. “1” for big and “0” for small.

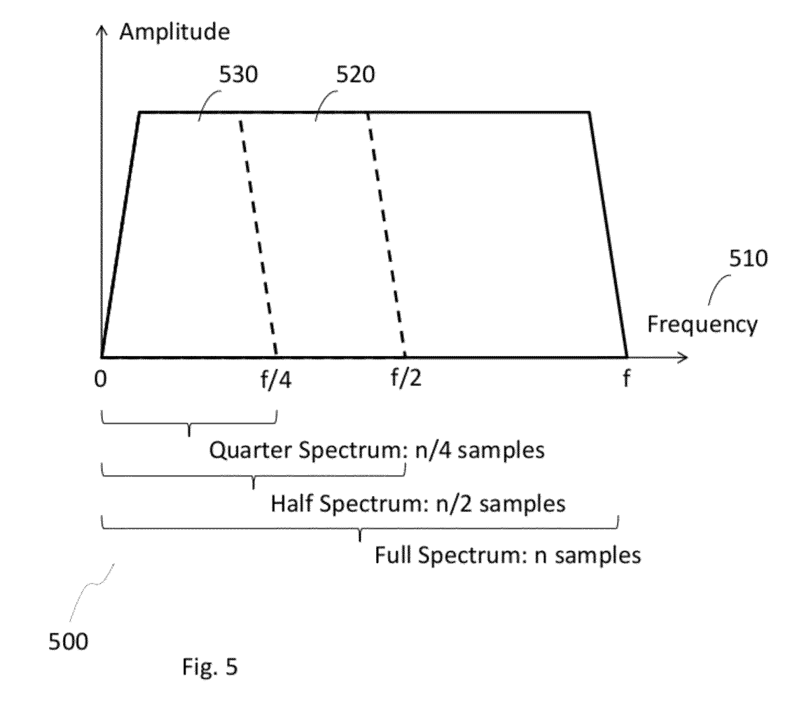

FIG. 5 is a block diagram (500) illustrating the interrelationship between the width of a frequency spectrum and the quantity of samples within the spectrum. More specifically, the frequency spectrum is shown on the horizontal axis of the graph (510). A full frequency spectrum has n quantity of sample data. By evaluating half of the spectrum, the quantity of sample data is reduced to half of the frequency, e.g. n/2, (520). Furthermore, by evaluating the quarter spectrum, which is one half of the half spectrum (520), the quantity of sample data is reduced to one quarter of the frequency, e.g. n/4, (530). Accordingly, reduction of sample data along the frequency may be entailed by adjusting the frequency spectrum along which the data sample is gathered.

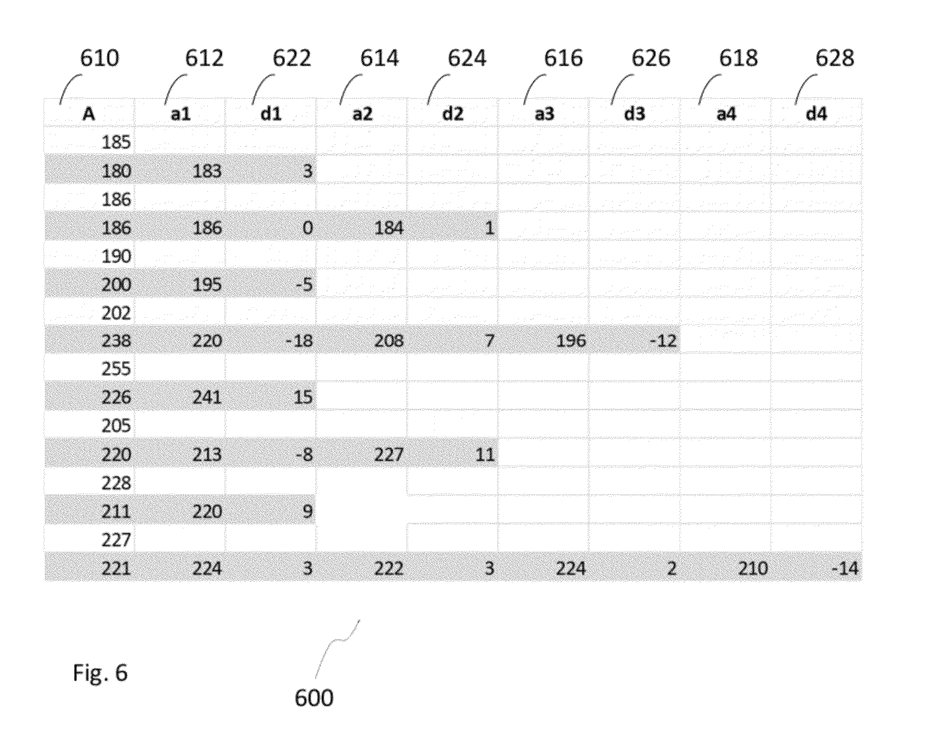

FIG. 6 is a block diagram (600) illustrating tabled data with the Haar wavelet transform consecutively applied. More specifically, column A (610) represents the raw sensor data. Columns a₁ (612), a₂ (614), a₃ (616) and a₄ (618) show low pass filtered data computed as an average of two sequential readings. Column d₁ (622), d₂ (624), d₃ (626), and d₄ (628) show high pass filtered data computed as an average difference of two sequential readings.

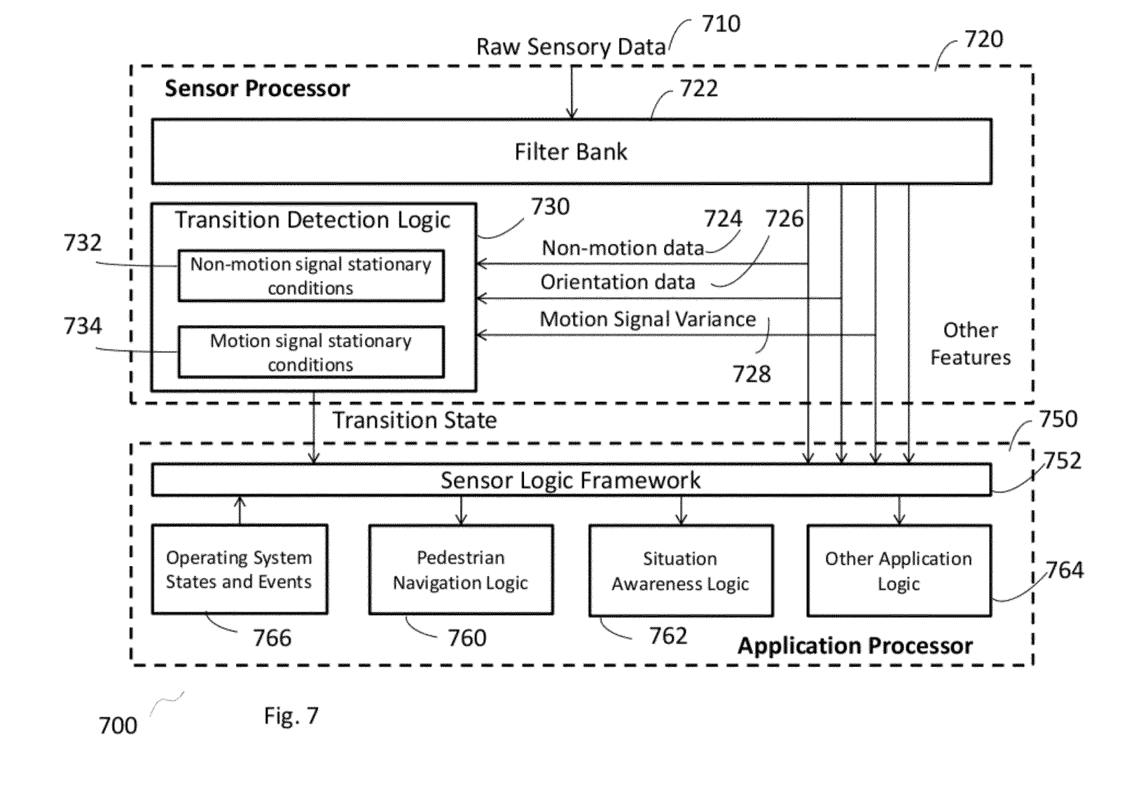

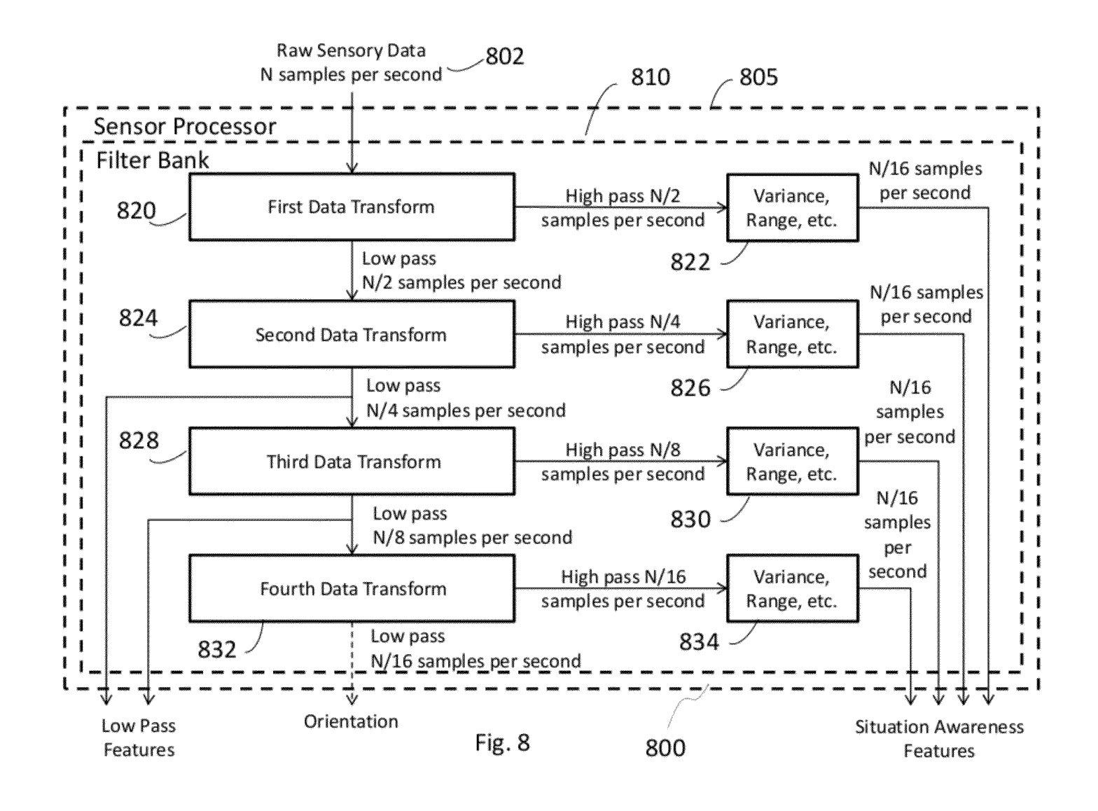

As described above, data received from a sensor is processed by a sensor processor to reduce or filter the raw data prior to forwarding the processed data to the application processor for further processing. FIG. 7 is a block diagram (700) illustrating the parsing of data by the sensor processor and communication of the processed data to the application processor. As shown, raw data (710) is communicated from the sensor to the sensor processor (720). Upon receipt of the sensor data by the sensor processor (720), the data is forwarded to a filter bank (722) to parse transition detection data, including but not limited to non-motion data (724), orientation data (726) and motion signal variance (728). Details of the functionality of the filter bank (722) are described in FIG. 8. The parsed transition detection data is forward to transition detection logic (730) to assess both non-motion signal stationary conditions (732) and motion signal stationary conditions (734). Accordingly, the filter bank (722) together with the transition detection logic (730) parses different characteristics of the raw sensory data (710).

Data is communicated from the sensor processor (720) to the application processor (750) as a continuous stream. More specifically, data pertaining to transition detection and data pertaining to situation awareness are separately communicated to the application processor (750). As shown, sensor logic framework (752) is embedded within the application processor (750) and functions as a gateway for receipt of both the transition detection data and the extracted features. The application processor (750) is provided with three distinct logic elements, including pedestrian navigation logic (760), situation awareness logic (762), and other application logic (764). Although three logic elements are shown herein, the invention should not be limited to this quantity, or to the specific logic elements shown. In one embodiment, the application processor (750) may be configured with additional and/or alternative logic elements embedded with the application processor (750), e.g. logic for user interface or life science applications. Each of the logic elements (760), (762), and (764), is configured to process the low rate data stream for a defined set of extracted features.

The application processor (750) or select logic (760), (762), and (764) embedded with the application processor (750) may be operating in a low power state until such time as the processor or select logic needs to return to an operating state. The advantage of placing the application processor or select logic embedded within the processor (750) in a low power state is the reduction in both power consumption and heat output. The sensor logic framework (752) communications with the operating system state (766) to select one of the embedded logic elements for processing received data. More specifically, sensor logic framework employs both the state of the operating system and received transition data to selectively wake-up an embedded logic element.

To further explain the functionality shown in FIG. 7, the pedestrian navigation logic is configured to extract characteristics pertaining to speed and heading, and the situation awareness logic (754) is configured to extract characteristics pertaining to device placement and environment. Each of the logic elements (760), (762), and (764) are configured to independently process the filtered data. A non-operating state of each of the logic elements (760), (762), and (764) is a low power state, such that when the logic element is not processing data the power for maintaining the associated logic element is mitigated. Conversely, each of the logic elements (760), (762), and (764), may be individually transitioned from the low power state to a high power state to support and enable feature processing. At such time as the feature processing is concluded by the select logic, the select logic returns to the low power state. Accordingly, the sensor processor (720) functions in conjunction with the application processor (750) for efficiently managing power consumption together with signal data processing.

FIG. 8 is a block diagram (800) further illustrating the functionality of the filter bank (722). Data is received from two or more sensors of a mobile device in the form of a data stream. Raw sensory data (802) is received by the filter bank (810) embedded within the sensor processor (805) as a stream of data. The filter bank (810) processes the data for high pass components and low pass components. More specifically, the raw data is applied to a first data transform (820) from which high pass and low pass components are extracted. In one embodiment, the Haar wavelet is employed by the first data transform for filtering the sensory data. However, the invention should not be limited to this specific data transform. In another embodiment, an alternative data transform may be applied to the raw data (802). The spectrum of the high pass data is split and statistical data is extracted therefrom (822). Statistical data includes, but is not limited to, variance, range, etc. The statistical data (822) is directly communicated to the application processor. See FIG. 7.

The spectrum of the low pass data is split and subject to a second data transform (824). Similar to the first data transform (820), high pass and low pass components are extracted by the second data transform (824). The spectrum of high pass data is split and statistical data is extracted therefrom (826), and communicated to the application processor. The spectrum of low pass data is split and subject to a third data transform (828). Similar to the second data transform (824), high pass and low pass component are extracted from the third data transform (828). The low pass features associated with the extracted components are communicated to both the application processor, see FIG. 7, and a fourth data transform (832). The high pass features associated with the extracted components (830) are communicated to the application processor. Further transformation of high and low pass data may continue with a fourth data transform (832) and so on with an associated high pass feature extraction (834). Division of the spectrum is dependent on a polling frequency of the sensors and selected applications. Accordingly, the low pass features are extracted from the raw data and communicated to the application processor for selection of an associated embedded logic.

The sensor logic framework (752) embedded in the application processor (750) receive transition data from the filter bank (810), as shown in FIGS. 7 and 8, to support a determination of the parsed data and whether the parsed data value(s) indicates further processing by the application processor (750). More specifically, the logic framework (752) functions to assess whether the transition state data has crossed a threshold setting. In one embodiment, the transition can be defined as acceleration in excess of a threshold. However, such assessment will lead to excessive wakeup time of the application processor. A more elaborate transition definition as a disruption of a stationary state of the sensory signal will provide better results. With such transition definition, continuation of walking or controlling the device with motion will not trigger a computationally expensive situation awareness signal processing by the application processor.

As shown in FIG. 7, the functionality of the filter bank conducts filtering for all application in a single location. Applications employed to support a user interface, navigation, device placement, etc. do not have to perform further signal processing. Accordingly, the filter bank filter sensor data on the sensor processor while mitigating multiple processing of the same data for each application running on the application processor.

Detection of the stationary process takes place based on features extracted for other signal processing purposes. In one embodiment, the extracted features include signal averages, and variances of selected spatial and spectral components over a period of time. The stationary process detection can be further augmented by additional change of state of a non-motion sensor. For example, in one embodiment a motion signal that is not stationary during a short period of time may be detected, thereby raising confidence of the decision to invoke the application processor through confirming a simultaneous change of state of a proximity sensor.

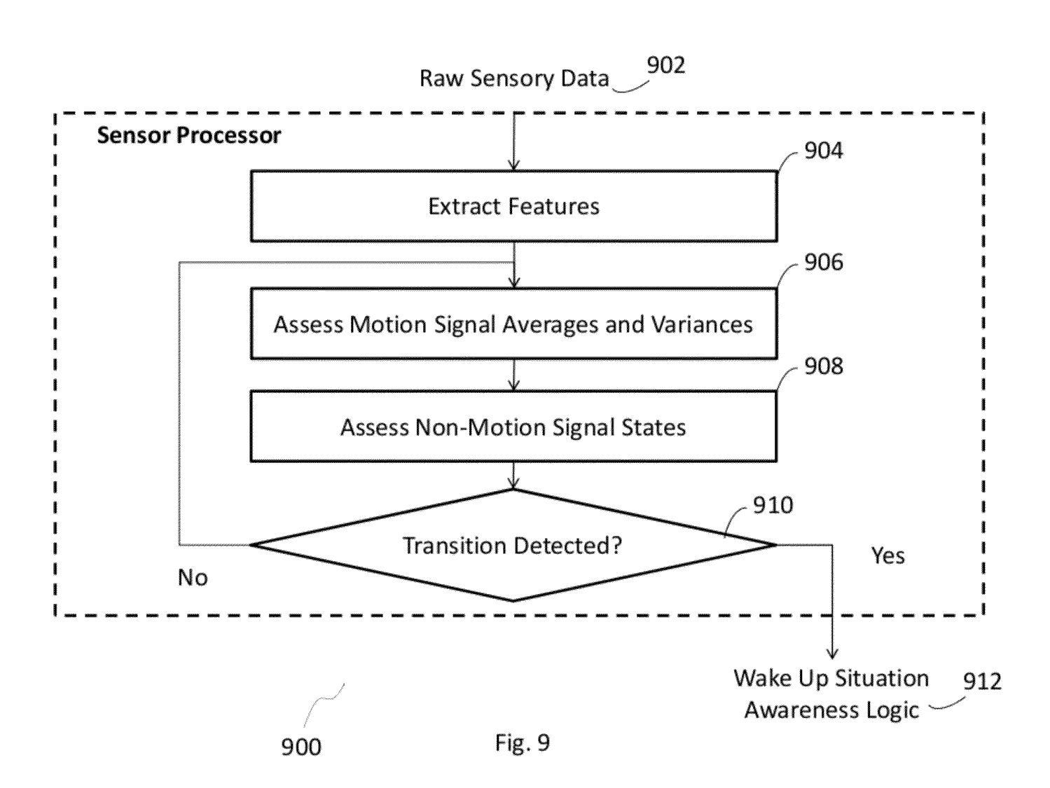

FIG. 9 is a flow chart (900) illustrating a process for changing an operating mode of the application processor. More specifically, the process illustrates transition detection based on classification of a motion signal and non-motion sensory data. Raw sensory data is received by the sensor processor (902) and features associated with the data are extracted (904). Details of feature extraction are shown in FIGS. 7 and 8. Based upon the extracted features, motion signal averages and/or variances are assessed (906), and non-motion signal states are assessed (908). It is then determined if transition motion of the mobile device was detected within the received data (910). A negative response to the determination at step (910) is followed by a return to step (906) for receipt and evaluation of future sensor data. However, a positive response to the determination at step (910) is followed by sending a signal to the situation awareness logic in the application processor for changing the operating mode of the logic (912).

The situation awareness logic on the application processor interprets situation awareness features received from the sensor processor. The situation awareness features includes: device orientations, states on non-motion sensors, including proximity, light, temperature, proximity, orientation, activity status, and high frequency noise. In one embodiment, correct interpretation of noises requires the motion signal to be stationary.

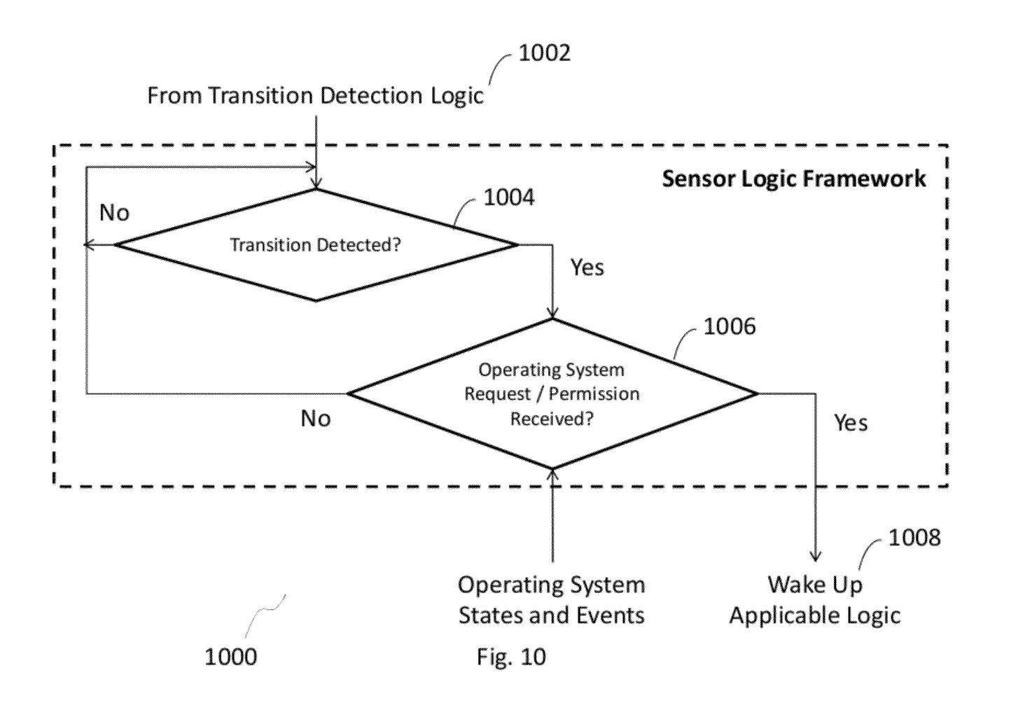

As explained in FIG. 7, the sensor logic framework functions together with the operating system to invoke the functionality of an embedded logic unit. FIG. 10 is a flow chart (1000) illustrating the use of the transition detection logic in conjunction with the application processor. As shown, data output is received from the transition detection logic (1002). It is then determined if a transition has been detected (1004). In one embodiment, transition pertains to a change of the physical location and placement of the associated mobile device. A negative response to the determination at step (1004) is following by a return to step (1002) for receipt of further transition logic assessment(s). However, a positive response to the determination at step (1004) is following by determining if permission has been requested or received from the operating system in communication with the application processor (1006). In one embodiment, the determination at step (1006) includes input in the form of the state and/or event(s) of the operating system. A positive response to the determination at step (1006) is following by activation of an applicable logic embedded within the application processor (1008). Conversely, a negative response to the determination at step (1006) is following by a return to step (1002) for receipt of further transition logic assessment (1002). Accordingly, the operating system state and events is employed as a factor in requesting activation of a specific logic embedded within the application processor.

As shown in the figures above, two processors are invoked to process data gathered from one or more sensors of a mobile device, with logic embedded within the application processor operating in a low power mode at such time as it is not processing data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may include, for example, but not be limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to a flowchart illustration and/or block diagrams of methods, apparatus (systems) and computer program products according to embodiments of the invention. It will be understood that each block of the flowchart illustration and/or block diagrams, and combinations of blocks in the flowchart illustration and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

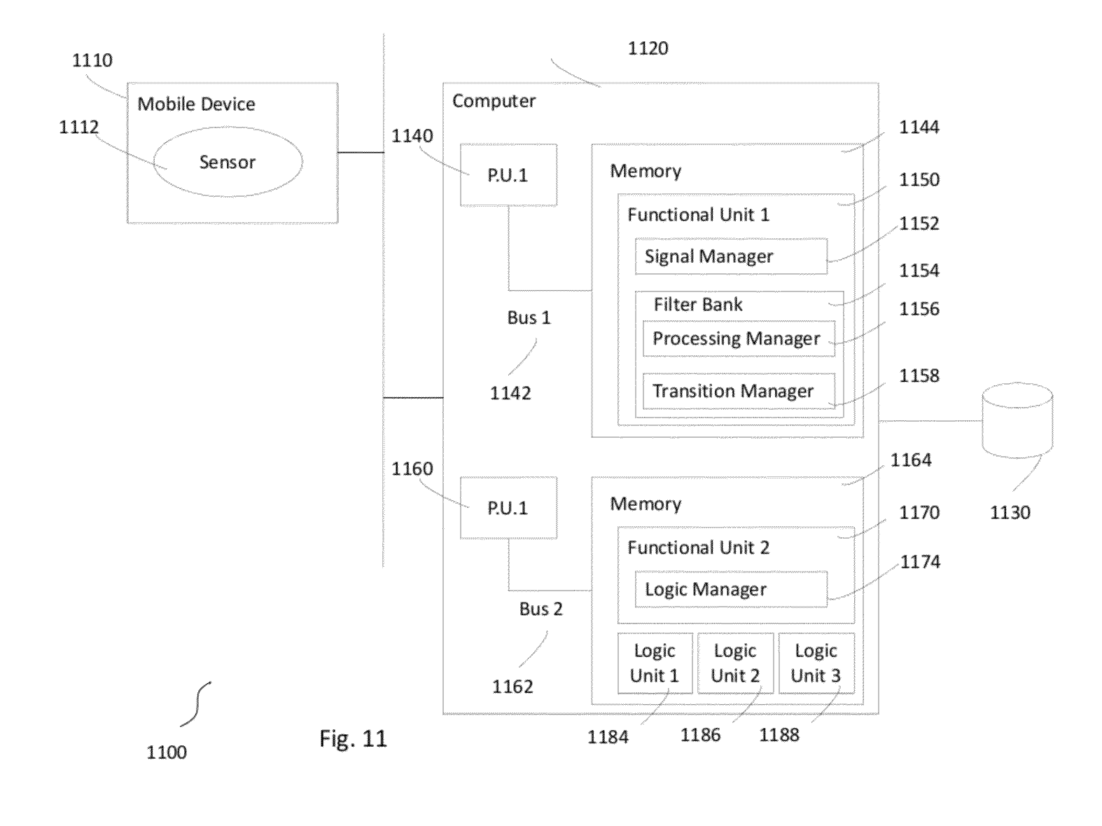

Referring now to FIG. 11 is a block diagram (1100) showing a system for implementing an embodiment of the present invention. The system includes a mobile device (1100) in communication with a computer (1120). The mobile device (1110) is provided with a sensor (1112) to generate motion signals when subject to motion. In one embodiment, the sensor (1112) is a tri-axis accelerometer, a dual axis sensor, gyroscope, etc. The mobile device (1110) communicates the motion signal to the computer (1120), which is configured with a processing unit (1122) in communication with memory (1124) across a bus (1126), and data storage (1130).

There are different tools employed to support motion signal processing with respect to a mobile device, wherein the signal processing may be employed for derivation of placement information for the mobile device (1110). For purposes of illustration, the tools will be described local to the computer (1120). In one embodiment, the tools may be local to the mobile device (1110). As shown herein, there are two processors, including a first processor (1140) and a second processor (1160). The first processor (1140) is provided with first memory (1142) and the second processor (1160) is provided with second memory (1162). In the example shown herein, the processors (1140) and (1160) are electronically separated and local to the mobile device. However, in another embodiment, one of the processors may be located remote from the mobile device (1110). For example, the first process may be a standalone processor, or a processor embedded into a sensor, a sensor package, or a second processor. The second processor is further provided with two or more embedded logic units (1164), (1166), and (1168). Each of the embedded logic units (1164)-(1168) supports processing a low rate data stream for a defined set of extracted features.

Each of the processors (1140) and (1160) is provided with a functional unit. More specifically, the first processor (1140) is provided with a first functional unit (1150) in communication with the first memory (1142). The first functional unit includes a signal manager (1152) to pre-process signal data from the sensor (1112) on behalf of the second processor (1160). The pre-processing by the signal manager (1152) includes conversion of high rate raw data received form the sensor (1112) into a low rate data stream of extracted features. The functionality of the signal manager (1152) reduces a size of the sensory data received from the sensor(s) (1112) with de-sampling, compression, or quantization, wherein quantization reduces a sample size and de-sampling reduces a quantity of data samples.

The second processor (1160) is provided with a second functional unit (1170) in communication with the second memory (1162). The second functional unit (1170) includes a logic manager (1174) in communication with each of the embedded logic units (1164)-(1168). More specifically, the logic manager (1174) selectively operates each of the logic units (1164)-(1168). The logic manager (1174) individually executes a first transition from a low power state to support feature processing and a second transition operating at a high power state to the low power state at a conclusion of feature processing. /

As shown herein the first processor (1140) is in local communication with a filter bank (1144). The filter bank (1144) includes a processing manager (1146) and a transition manager (1148). The processing manager (1146) supports signal pre-processing and the transition manager (1148) supports selective determination of one of the logic units (1164)-(1168). In one embodiment, the transition manager (1148) evaluates a signal condition, including non-motion stationary signal data or motion stationary signal data. In response to the functionality of the processing manager (1146) and the transition manager (1148), the filter bank (1144) communicates non-motion data, orientation data, and motion signal variance to the transition detection logic.

Data is received by the first processor (1140) from the sensor (1112) at a polling date. The configuration of the first and second processors (1140) and (1160) is such that a data exchange between the second processor (1160) and the first processor (1140) is lower than the polling date of the sensor(s) (1112).

As identified above, the managers and filter bank are shown residing in memory of the machine in which they reside. As described above, in different embodiment the managers and filter bank may reside on different machines in the system. In one embodiment, the managers and the filter bank may reside as hardware tools external to memory of the machine in which they reside, or they may be implemented as a combination of hardware and software. Similarly, in one embodiment, the managers and filter bank may be combined into a single functional item that incorporates the functionality of the separate items. As shown herein, each of the manager(s) and filter bank are shown local to one machine. However, in one embodiment they may be collectively or individually distributed across a set of computer resources and function as a unit to manage signal processing with respect to situational awareness. Accordingly, the managers may be implemented as software tools, hardware tools, or a combination of software and hardware tools.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
one or more sensors in communication with at least two processors, including a first processor in communication with a second processor, the first processor pre-processing signal data from the one or more sensors for the second processor, the signal pre-processing including converting a high rate raw data stream from the one or more sensors into a low rate data stream of extracted features;
configuring the second processor with two or more logic elements, each logic element configured to process the low rate data stream for a defined set of extracted features; and
selectively operating each configured logic element of the second processor, including transitioning one of the select logic elements from a low power state to a high power state to support feature processing, and transitioning one of the select logic elements operating at the high power state to the low power state at a conclusion of feature processing.

2. The method of claim 1, further comprising configuring the first processor with a filter bank for the signal pre-processing and transition detection logic for selectively determining a logic element of the second processor, wherein the filter bank communicates non-motion data, orientation data, and motion signal variance to the transition detection logic.

3. The method of claim 1, the transition detection logic further comprising instructions for evaluation signal conditions selected from the group consisting of: non-motion stationary, and motion stationary.

4. The method of claim 1, wherein selectively operating each configured logic element of the second processor reduces signal data processing by the second processor.

5. The method of claim 1, wherein the second processor and the first processor are electronically separated.

6. The method of claim 1, wherein the first processor has a physical proximity relationship with the second processor selected from the group consisting of: a standalone processor and a processor embedded into an element selected from the group consisting of: a sensor, a sensor package, and the second processor.

7. The method of claim 1, wherein a data exchange rate between the second processor and the first processor is lower than a polling rate of the one or more sensors.

8. The method of claim 1, wherein the logic elements of the second processor include at least pedestrian navigation logic, situation awareness logic, and other application logic.

9. The method of claim 8, wherein the situation awareness includes an environmental situation change, and the change is selected from the group consisting of: light, temperature, proximity, orientation, and activity status.

10. The method of claim 1, further comprising the first processor reducing a size of the sensory data received from the one or more sensors with a technique selected from the group consisting of: de-sampling, compression, and quantization, wherein the quantization technique reduces the size of a sample or feature, and the de-sampling technique reduces a quantity of data samples.

11. The method of claim 1, further comprising the first processor pre-processing signal data from the one or more sensors including reducing a size of the sensory data received from the two or more sensors with a technique selected from the group consisting of: co-variance and correlation or their mathematical approximations.

12. The method of claim 1, further comprising the first processor extracting situation awareness information from the sensory signal, the situation awareness selected from the group consisting of: device placement and user activity classification.

13. A system comprising:
a mobile device having a sensor to generate a motion signal;
a computer system in communication with the mobile device, the computer system including a first processor and a second processor;
the first processor in communication with first memory, and the second processor in communication with second memory;
the second processor configured with two or more embedded logic elements, each logic element to process the low rate data stream for a defined set of extracted features;
a first functional unit in communication with the first memory, the first functional unit comprising a signal manager to pre-process signal data from the sensor for the second processor, including a conversion of high rate raw data from the sensor into a low rate data stream of extracted features; and
a second functional unit in communication with the second memory, the second functional unit comprising:
a logic manager to selectively operate each configured logic element of the second processor, and for each select logic element individually executes a first transition from a low power state to support feature processing and executes a second transition operating at a high power state to the low power state at a conclusion of feature processing.

14. The system of claim 13, further comprising a filter bank local to the first processor, the filter bank having a processing manager to support signal pre-processing and a transition manager in communication with the processing manager, the transition manager to selectively determine a logic element in communication with the second processor, wherein the filter bank communicates non-motion data, orientation data and motion signal variance to the transition detection logic.

15. The system of claim 14, further comprising the transition manager to evaluate a signal condition selected from the group consisting of: non-motion stationary, and motion stationary.

16. The system of claim 12, wherein the second processor and the first processor are electronically separated r.

17. The system of claim 12, wherein the first processor has a physical proximity relationship with the second processor selected from the group consisting of: a standalone processor and a processor embedded into an element selected from the group consisting of: a sensor, a sensor package, and the second processor.

18. The system of claim 12, wherein a data exchange rate between the second processor and the first processor is lower than a polling rate of the one or more sensors.

19. The system of claim 18, wherein the situation awareness includes an environmental situation change, and the change is selected from the group consisting of: light, temperature, proximity, orientation, and activity status.

20. The system of claim 12, further comprising the first processor reducing a size of the sensory data received from the one or more sensors with a technique selected from the group consisting of: de-sampling, compression, and quantization, wherein the quantization technique reduces the size of a sample, and the de-sampling technique reduces a quantity of data samples.

21. A computer program product for use with a mobile device, the mobile device having a sensor to generate a motion signal, the computer program product comprising a computer readable storage medium having computer readable program code embodied thereon, which when executed causes a computer to implement the method comprising:
setting a first processor in communication with a second processor;
configuring the second processor with two or more logic elements, each logic element configured to process the low rate data stream for a defined set of extracted features;
receiving data from at least one of the sensors, including:
the first processor pre-processing signal data from the one or more sensors for the second processor, the signal pre-processing including converting a high rate raw data stream from the one or more sensors into a low rate data stream of extracted features; and
selectively operating each configured logic element of the second processor, including transitioning one of the select logic elements from a low power state to a high power state to support feature processing, and transitioning one of the select logic elements operating at the high power state to the low power state at a conclusion of feature processing.

22. The computer program product of claim 21, further comprising configuring the first processor with a filter bank for the signal pre-processing and transition detection logic for selectively determining a logic element of the second processor, wherein the filter bank communicates non-motion data, orientation data, and motion signal variance to the transition detection logic.

23. The computer program product of claim 22, wherein the transition detection logic further comprising instructions for evaluation signal conditions selected from the group consisting of: non-motion stationary, and motion stationary.

24. The computer program product of claim 21, wherein selectively operating each configured logic element of the second processor reduces signal data processing by the second processor.

25. The computer program product of claim 21, wherein the second processor and the first processor are electronically separated.

26. The computer program product of claim 21, wherein the first processor has a physical proximity relationship with the second processor selected from the group consisting of: a standalone processor and a processor embedded into an element selected from the group consisting of: a sensor, a sensor package, and the second processor.

27. The computer program product of claim 21, wherein a data exchange rate between the second processor and the first processor is lower than a polling rate of the one or more sensors.

28. The computer program product of claim 21, wherein the logic elements of the second processor include at least pedestrian navigation logic, situation awareness logic, and other application logic.

29. The computer program method of claim 28, wherein the situation awareness includes an environmental situation change, and the change is selected from the group consisting of: light, temperature, proximity, orientation, and activity status.

30. The computer program product of claim 21, further comprising the first processor reducing a size of the sensory data received from the one or more sensors with a technique selected from the group consisting of: de-sampling, compression, and quantization, wherein the quantization technique reduces the size of a sample, and the de-sampling technique reduces a quantity of data samples.

31. A distributed signal processing method for mobile devices with sensors and at least two processors, comprising:
one or more sensors are in communication with a first processor and the first processor is in communication with a second processor;
the first processor pre-processing signal data from the one or more sensors for the second processor, the signal pre-processing including filtering and splitting the signal data into multiple outputs representing spatial and spectral components, and statistical properties of the components; and
the second processor running one or more sensory applications utilizing selected outputs from the first processor.

32. The distributed signal processing method of claim 31, wherein the statistical properties include an item selected from the group consisting of: averages, ranges, modes, medians, variances, co-variances, and associated mathematical approximations.
